(19) United States
(12) Patent Application Publication
(10) Pub. No.: US 2008/0102864 A1
(43) Pub. Date: May 1, 2008

(54) System and method for running an international telephony messaging campaign

(76) Inventor: Garry T. Donoghue, Queensland (AU)

Correspondence Address: YOUNG & THOMPSON, 209 Madison Street, Suite 500, ALEXANDRIA, VA, 22314, US

(21) Appl. No.: 11/586,507

(22) Filed: Oct. 26, 2006

(51) Int. Cl. H04Q 7/20

(52) U.S. Cl. 455/466

(57) ABSTRACT

A method of running a telephony messaging (e.g., SMS) campaign directed at users in a plurality of countries is provided. An international messaging destination number is selected for the campaign and comprises an international country code for a particular country or region followed by a national destination number for that particular country or region. Users are invited to participate in the campaign by communicating the international messaging destination to the users in the format of an international direct dialing prefix followed by a string comprising at least one letter conventionally associated, on a standard telephone keypad, with at least one digit in the international country code of the international messaging destination number. A system and method for facilitating the widespread adoption of international destination numbers in telephony messaging campaigns and for sharing in the mobile network revenue associated with the message traffic generated by those campaigns is also disclosed.

### FIELD OF THE INVENTION

The present invention relates to a system and method of running an electronic messaging campaign, especially an SMS campaign, directed at users in a plurality of countries.

### BACKGROUND OF THE INVENTION

The Short Message Service (SMS) is a telephony messaging service available on most digital wireless communication networks that enables short messages—also known as text messages or texts—to be sent or received via a user's communication device, typically a mobile telephone. Although the SMS protocol was originally designed as a service in GSM wireless networks, SMS is now available on a wide range of networks, including 3G networks, and is effectively becoming a worldwide mobile data service. As such, both within the United States and internationally, the use of SMS communication continues to grow very rapidly.

Wireless network users commonly use SMS messages to communicate with other users. In this case, the user simply enters or identifies a destination number that corresponds to another user's mobile telephone number. Increasingly, SMS is also being used in connection with marketing, advertising, games, and other publicly-run campaigns. For instance, users often send SMS messages to order or receive services (e.g., mobile telephone ring tones), to participate in a survey, to vote in a contest, to enter into a game or lottery, or to pay for a service. As a result, from a marketing perspective, SMS has become an important tool for enabling companies and brand owners to communicate personally with their existing and prospective customers.

In such SMS campaigns, the destination number is normally a dedicated short code number that has fewer digits than a standard telephone number. The short code is associated with an SMS application capable of automatically receiving and processing messages, orders, or entries in high volume from multiple users. Such messages may be premium-rated short messages (PSMS) meaning that the user is charged a higher rate for sending the message. The amount of this premium is typically divided between the mobile network operator and the content provider, for example, through a revenue sharing agreement or a fixed transport fee.

Short codes are normally “common” in that the same short code number works for multiple participating wireless network operators in a given country or international dialing region. The format and administration of short code numbers varies, although generally speaking any destination number or short code must be licensed from a relevant administrator, and the numbers are never effectively owned by a content or application provider. Several countries have a centralized short code administration body. For example, in the United States the Common Short Code Administrator (CSCA) administers the assignment of SMS short codes which currently may be either 5 or 6 digits long. Similarly, in the United Kingdom the Short Code Management Group (SCMG) assigns short code numbers that are 4, 5 or 6 digits in length. Even in countries where a centralized administration body does not exist, in most cases regional mobile network operators, governments, and/or industry associations in that region have set up (or are in the process of setting up) procedures for licensing short codes for SMS campaigns.

Moreover, in most countries, short codes may be either random or of the “vanity” type where a potential licensee can choose a specific short code in view of its commercial significance. In particular, similar to vanity toll-free telephone numbers, there is considerable commercial interest in the use of mnemonic short code numbers that can correspond (at least in part) to a particular word or trademark based on the letters commonly associated with the numbers 2 through 9 on a standard telephone keypad. Such vanity short codes are notably easier for potential users to remember, and they may also serve to reinforce brand messaging and recognition.

Unfortunately however, because the applicability of a given short code is specific to a given country or international dialing region, parties running commercial or other high-volume SMS campaigns across different countries currently have to obtain, activate, and advertise different short code numbers in each region. This poses a significant burden on the party organizing the campaign since it must apply for, implement and manage short codes in different countries. Furthermore, it is difficult to obtain the same vanity short code in multiple regions. In view of this, there is a need for a more effective system and method of running high-volume SMS campaigns internationally.

### SUMMARY OF THE INVENTION

The present invention provides a system and method of running an international telephony messaging (in particular, SMS) campaign for users in different countries that does not suffer from the drawbacks associated with using different destination numbers in different countries.

In accordance with the invention, an international messaging destination number (e.g., an international SMS destination number) is selected for users to participate in the campaign. The destination number comprises an international country code for a particular country or region followed by a national destination number for that particular country or region. The international country code comprises one or more digits, and the national destination number (which may be a short code) comprises a plurality of digits. Users are invited to participate in the campaign by communicating the international messaging destination to the users in the format of an international direct dialing prefix followed by a string comprising one or more letters conventionally associated, on a standard telephone keypad, with at least one digit in the international country code of the international messaging destination number. Preferably, all of the digits in the country code and at least some of the digits in the national destination number are communicated using letters corresponding to those digits, such that the letters make up a particular word or trademark. Also, the international direct dialing prefix can conveniently be communicated to all users as a ‘+’ sign, the latter being representative of the international direct dialing access code from the particular countries in which the users may be based.

In another aspect, the present invention provides a method for running a plurality of telephony messaging campaigns, each directed at users in a plurality of countries. In this aspect, the rights to use a plurality of international messaging destination numbers in a plurality of countries are acquired, where each international messaging destination number comprises an international country code for a particular country or region followed by a national destination number for that particular country or region. As noted above, the international country code comprises one or more digits, and the national destination number comprises a plurality of digits. Each international messaging destination number is associated with a telephony messaging campaign run by a campaign manager. For each telephony messaging campaign, telephony messages from users who participate in the campaign are received via a plurality of telephony messaging operators located in the plurality of countries. Those telephony messages are forwarded to the campaign manager for that campaign, and each telephony messaging operator is charged an amount based on the telephony messages delivered via said telephony messaging operator.

The telephony messages may be received via a plurality of messaging hub operators, in which case each messaging hub operator is charged a portion of the mobile network charge revenues incurred by users whose telephony messages are delivered via that messaging hub operator. Alternatively (or additionally), the telephony messages may be received via a plurality of mobile network operators, and in that case each mobile network operator is charged a portion of the mobile network charge revenues incurred by users whose telephony messages are delivered via that mobile network operator. Optionally, a portion of the amount charged to telephony messaging operators in connection with a particular telephony messaging campaign is provided to an administrator who granted the rights to use the associated international messaging destination number.

As described above, for each telephony messaging campaign, users to are preferably invited to participate in the campaign by communicating the international messaging destination to the users in the format of an international direct dialing prefix followed by a string comprising at least one letter conventionally associated, on a standard telephone keypad, with at least one digit in the international country code of the international messaging destination number.

In another aspect, the present invention provides a system for running a telephony messaging campaign directed at users in a plurality of countries. The system comprises a messaging handling system operative to associate each of a plurality of international messaging destination numbers with a telephony messaging campaign run by a campaign manager. Again, each international messaging destination number comprises an international country code for a particular country or region followed by a national destination number for that particular country or region (the international country code comprising one or more digits and the national destination number comprising a plurality of digits). The messaging handling system is further operative to receive, via a plurality of telephony messaging operators located in the plurality of countries, telephony messages from users who participate in each telephony messaging campaign and to forward the telephony messages to the campaign manager for said campaign. The system also comprises a billing and rating system operative to charge each telephony messaging operator an amount based on the telephony messages delivered to the message handling system via that telephony messaging operator.

The messaging handling system may receive telephony messages via a plurality of messaging hub operators, in which case the billing and rating system charges each messaging hub operator a portion of the mobile network charge revenues incurred by users whose telephony messages are delivered via said messaging hub operator. Alternatively or additionally, the messaging handling system may further comprise a hub for receiving telephony messages directly via a plurality of mobile network operators, and the billing and rating system may charge each mobile network operator a portion of the mobile network charge revenues incurred by users whose telephony messages are delivered via that mobile network operator. Optionally, the billing and rating system may pay a portion of the amount charged to telephony messaging operators in connection with a particular telephony messaging campaign to an administrator who granted the rights to use the international messaging destination number associated with said campaign.

### BRIEF DESCRIPTION OF THE DRAWINGS

The objects and advantages of the present invention will be better understood and more readily apparent when considered in conjunction with the following detailed description and accompanying drawings which illustrate, by way of example, preferred embodiments of the invention and in which:

FIG. 1 is a schematic overview illustrating a system for acquiring and managing international SMS destination numbers together with other parties and systems in an SMS communication network; and

FIG. 2 is a flow diagram illustrating the operation of an international SMS campaign involving the system for acquiring and managing international SMS destination numbers in FIG. 1.

### DETAILED DESCRIPTION OF PREFERRED EMBODIMENTS

The present invention is described below in connection with SMS campaigns and the SMS messaging protocol. However, the system and method of the present invention are not dependent on the specifics of the telephony messaging protocol used, and they can more generally be applied to any messaging protocol in which the destination addresses are telephone or short code numbers.

In accordance with preferred embodiments, the present invention enables international SMS campaigns to be run using a single international SMS destination number whose country code and short code digits correspond, at least in part, to a desired word, trademark, or other memorable alphanumeric string. It will be appreciated that all trademarks mentioned below are the property of their respective owners, and therefore they cannot be used in commerce without appropriate authorization—they are mentioned below as illustrative examples only. The international SMS destination number (or more generally, any international messaging destination number) has the following format, including three fields:

(international prefix) (country code) (national destination number)

The international prefix field in the above format represents the international direct dialing (IDD) prefix or access code from the country in which a user or potential participant is based, and as is well known always precedes the country code in international dialing. The IDD prefix for the United States and Canada is ‘011’ while for most of Europe it is ‘00’. Several other IDD prefixes are used in various countries around the world. Due to the different IDD prefixes in use worldwide, the use of a ‘+’ sign has become increasingly common, particularly in GSM networks, to represent the IDD prefix whatever it may be. In fact, users in many communication networks can automatically invoke the correct IDD for whatever country they may be in by inserting a ‘+’ sign at the start of an international destination number (SMS or otherwise). On many mobile communication devices, the ‘+’ sign is inserted simply by pushing and holding the ‘0’ key of the device.

In a preferred embodiment, the ‘country code’ field in the above format corresponds at least in part to letters representing the digits of the international country code for the country in which the SMS destination number or short code is administered. As is well known, international country codes are used to identify specific countries or geographical areas (as well as in some cases global communication services) when communicating by telephone between countries. These country codes are assigned and administered by the International Telecommunications Union (ITU) based in Geneva, Switzerland and are listed in the ITU publication “List of ITU-T Recommendation E.164 Assigned Country Codes”, Annex to ITU Operational Bulletin No. 851-1.I.2006, the contents of which are incorporated herein by reference. This document is available on the ITU Web site (www.itu.int). It should be noted that the term “country” as used herein includes any geographic region that has been assigned a country code regardless of the region's political status.

The ‘national SMS destination number’ field in the above format corresponds to the digits, and/or the letters representing the digits, of the SMS destination number or short code specifically selected from the corresponding administrator or providers in the particular country. This number normally comprises two parts: a national destination code (NDC) and a subscriber number (SN). As noted above, at present most countries either have or are in the process of setting up a system for administering SMS destination numbers including short codes (i.e., destination numbers comprising fewer digits than a telephone number), and in most cases the licensee of the SMS destination number has the ability to select the digits of the destination number (although this will depend on availability and in some cases other criteria such as minimum number-length requirements).

In accordance with preferred embodiment, at least part of the international SMS destination number, including at least one digit of the country code, is advantageously communicated to users or potential participants of the SMS campaign using the letters commonly associated with the numbers on a standard telephone keypad, i.e.:

0 no letters

1 no letters

2 A, B or C

3 D, E, or F

4 G, H, or I

5 J, K, or L

6 M, N, or O

7 P, Q, R, or S

8 T, U, or V

9 W, X, Y, or Z.

In this manner, a destination number having the above format for an international SMS campaign can be clearly communicated by any suitable medium (for e.g., the internet, television, or radio) to potential participants in different countries using the ‘+’ sign and a desired word, trademark, or string.

For example, the destination number for an international SMS campaign may be communicated to potential participants as:

+PEPSI (i.e., +7 3774, a snort code number based in Russia),

+CARLSBERG (i.e., +227 57 2374, a short code number based in Niger),

+YAHOO (i.e., +92 466, a short code number based in Pakistan)

+HOTELS (i.e., +46 7357, a short code number based in Sweden).

In a preferred embodiment, both the full country code and most or all of the national SMS destination number correspond to the desired word or trademark so that only a few or no additional digits need be displayed or communicated to potential participants. Where a country or short code administrator imposes a minimum number-length requirement, it may also desirable to augment a mnemonic string using further letters or words rather than numbers. For example, since United Kingdom short codes must be at least 4 digits in length, the international SMS destination number +GIFT would still require two further digits to form a valid U.K. short code number. In such a case, the campaign may still be run effectively as, for example, +GIFT BUY.

In view of their specific country codes, SMS destination numbers in certain countries may be preferred for international SMS campaigns in accordance with the invention. In most cases, the international country codes are either two or three digit numbers. However, the single digit country code ‘1’ corresponds to the North American Numbering Plan Area including the United States, Canada, and parts of the Caribbean. Similarly, the single digit country code ‘7’ corresponds to the Russian Federation and the Republic of Kazakhstan. Thus, for instance, SMS destination numbers in Russia/Kazakhstan are particularly advantageous since they can potentially correspond to any word or trademark beginning with the letters P, Q, R or S—of which there are many thousands of possibilities.

On the other hand, certain other countries are less preferable due to the sequence of letters associated with the country code. For example, the country code ‘55’ for Brazil offers the letter combinations JJ, JK, JL, KJ, KK, KL, LJ, LK and LL, providing little option for SMS destination numbers that can be presented as words or trademarks (although there are some exceptions, such as +KLEENEX and +LLOYDS).

Similarly, countries with a ‘0’ or a ‘1’ in their country codes such as Malaysia (with country code ‘60’) or the Netherlands (with country code ‘31’) may also be less preferable since there are no letters associated with the digits ‘0’ and ‘1’. However, in some cases, destination numbers in these countries may still be desirable in order to obtain a particular alphanumeric string—for e.g., the Netherlands based SMS destination number +F1 GP (i.e., +31 47). More generally, for other desired trademarks or alphanumeric strings, only part of the country code in a destination number may be communicated to potential participants in the form of letters, such as +3M POST-IT which corresponds to the Hungary-based SMS destination number +36 767848.

Thus, in accordance with the present invention, a single global SMS destination number can be communicated to potential participants of an internationally-run SMS campaign. For instance, transnational television broadcasters can use a single international SMS destination number to market their activities in all or most of the countries in which they broadcast. This alleviates the burdens and drawbacks of prior international SMS campaigns in which lists of domestic SMS destination numbers had to be licensed, activated, managed, and communicated to users by the party running the campaign. The present invention provides the additional advantage of communicating at least part of the international SMS destination number to the users in a mnemonic format that can be more easily remembered and associated with the campaign. More particularly, the format ‘+{string}’ comprises an international direct dialing prefix followed by a string comprising at least one letter conventionally associated with at least one digit in the international country code of the international SMS destination number. Preferably, several (and more preferably all) digits from both the country code and the national SMS destination number are more clearly and simply displayed as letters of a word or trademark to further enhance these branding advantages. Also, by communicating the number using the ‘+’ sign to represent the IDD prefix, the number can be displayed in a compact and user friendly format. It should be noted that even an SMS user located within the country in which the international destination SMS number can use the ‘+’ sign or IDD prefix when entering the destination number on the device, since the SMS can still be delivered (in most cases, simply as a national SMS message would).

Companies, brand-owners, and other content providers may select an appropriate international SMS destination number and thereby use it in an SMS campaign by directly licensing the international SMS destination numbers from an SMS or short code number administrator in the relevant country. However, in other embodiments, the present invention further provides a system and method for facilitating the more widespread adoption of international SMS destination numbers in SMS campaigns and for sharing in the mobile network revenue associated with the SMS message traffic generated by those campaigns.

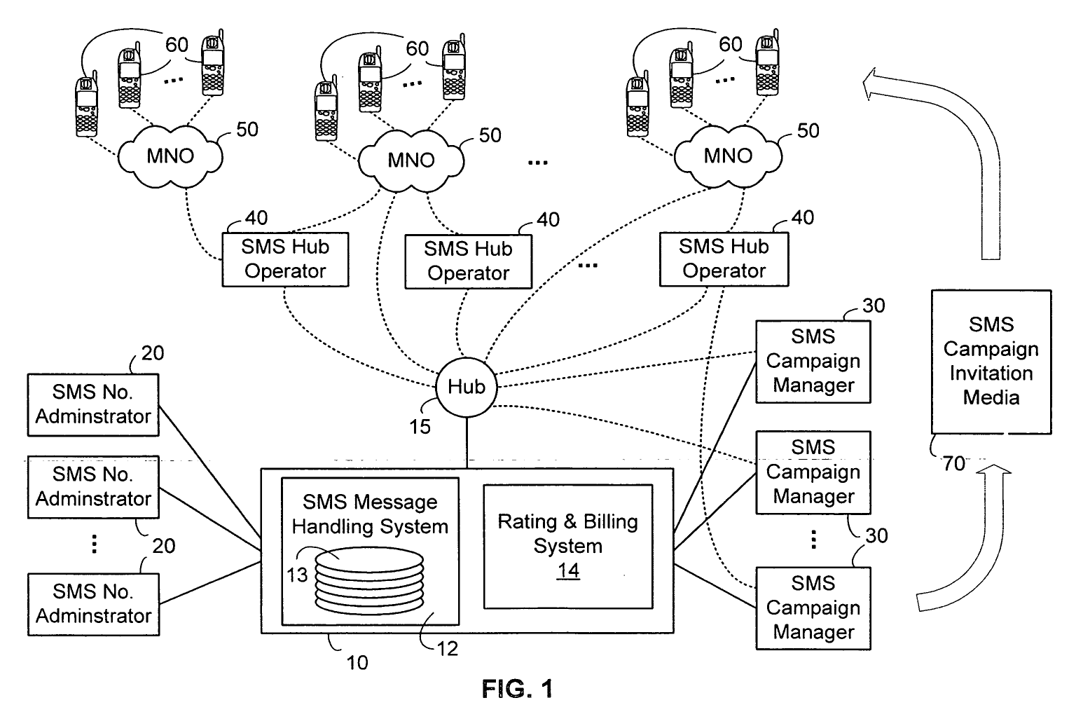

In accordance with a preferred embodiment, FIG. 1 is a general schematic overview illustrating how such a system 10 for acquiring and managing international SMS destination numbers interacts with other parties and systems in an SMS communication network. System 10 includes an SMS message handling system 12 (comprising centralized application servers 13), a rating and billing system 14, and preferably also its own SMS hub 15. Hub 15 may operate in a 1:1 redundant configuration with a hot standby node in a geographically diverse location from hub 15. As shown, in addition to system 10, the SMS communication network includes SMS number administrators 20, SMS campaign managers 30, SMS hub operators 40, mobile network operators (MNOs) 50 and SMS users 60—all of which may generally be based in any country worldwide.

In the SMS protocol, SMS messages are normally transmitted between mobile network operators 50 in a store and forward manner using short message service centers (SMSCs). Increasingly, however, SMS hubs 40 capable of monitoring and controlling high volumes of SMS traffic are performing (and in some cases effectively superseding) the SMSC store and forward function. As shown in FIG. 1, SMS hubs 40 may be connected to a number of mobile network operators 50. SMS Hub 15 in system 10 may in turn connect directly to certain mobile operators 50 as well as to other hub operators 40.

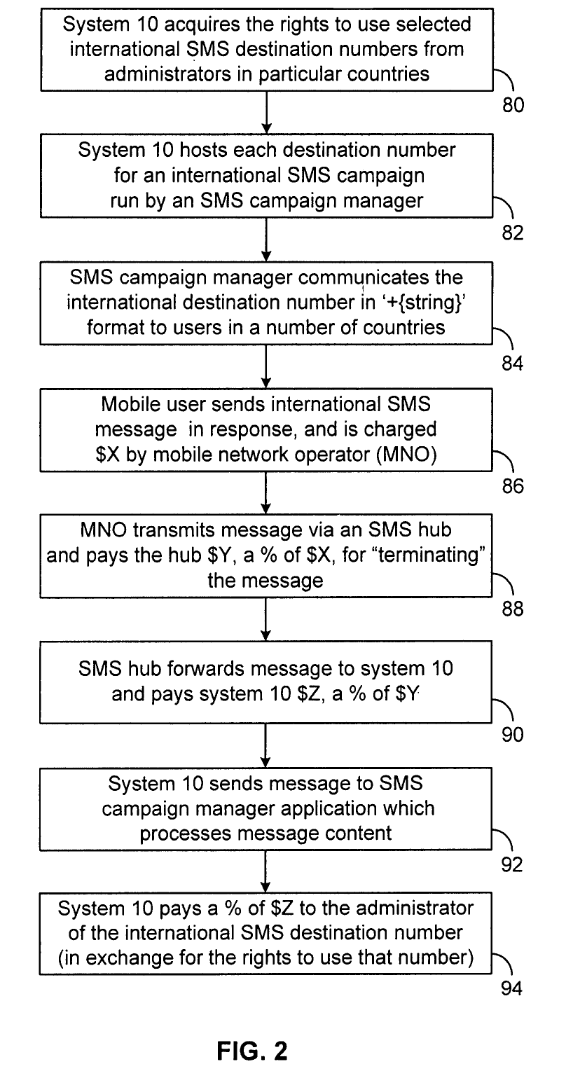

FIG. 2 is a flow diagram illustrating the operation of an international SMS campaign involving system 10 and the other entities identified in FIG. 1 in an embodiment of the invention. In step 80, the rights to use a variety of international SMS destination numbers in international SMS campaigns are acquired from the relevant SMS number (e.g., short code) administrators 20 in different countries. For example, the short code administrator SMSmail based in Moscow provides 4-digit short codes for Russia (country code ‘7’) operable on the networks of several leading Russian mobile network operators. Administrators 20 may of course also administer other national destination numbers in addition to those capable of being used for SMS communication. The arrangements necessary to obtain the right to use destination numbers typically take the form of a fixed term contract and/or an operator license, depending on the regulatory regime and market conditions in the country. While system 10 may make an initial payment to obtain the rights to international SMS destination numbers, system, as described below, these rights may alternatively be obtained from SMS number administrators 20 in exchange for a share in the revenue generate by system 10 from associated SMS campaigns.

Since system 10 operates its own SMS hub 15 (including an SMSC and a Visitor Location Register for maintaining mobile user identification and location information), system 10 may advantageously “host” international SMS destination numbers as described below. Optionally, system 10 may further provide desired ASP or CSP services on behalf of SMS campaign managers 30.

Once the rights to use specific international SMS destination numbers have been obtained, those numbers may then be used in various international SMS campaigns run by SMS campaign managers 30—if necessary with the permission of any relevant brand owner—interested in using one or more of the destination numbers licensed to system 10. For example, SMS campaign managers 30 may be interested in a mnemonic international SMS destination number that corresponds to a generic term or service that is easily recognized and understood by users such as +HOTELS. Such generic destination numbers may be considered particularly valuable in certain markets, in which case system 10 may also charge fees for sublicensing its use to a given SMS campaign manager 30.

As indicated at 82 and 84 in FIG. 2, international SMS campaigns may then be run such that the international SMS destination number is communicated (via media 70 in FIG. 1), to users in different countries using the mnemonic and/or brand-friendly format of ‘+{string}’ described above. Suitable communication media include the Internet and radio or television announcements (whether as part of programming or advertising). As noted above, the international SMS campaign may invite SMS users 60 to participate for any desired reasons be they commercial, charitable, educational, administrative, governmental, or otherwise in nature. As typical examples, SMS campaigns may invite users to participate in a game, vote in a contest, or purchase a service. As is well known, SMS campaign managers 30 may optionally employ application service providers (ASP) and content service providers (CSP) in the marketing and communications industries to more effectively run international SMS campaigns on their behalf.

At step 86, SMS users 60 who may be located within different countries and who are interested in participating in the SMS campaign send SMS messages, including if appropriate any user-generated content, to the international SMS destination number associated with the campaign. The mobile network operator 50 of the user sending the SMS message enables the international transmission of the message by routing the message to a particular SMS hub 40 at step 88. As shown at step 90, that hub in turn forwards the message to system 10 where it is received and handled by sub-system 12. Alternately, the sending user's mobile network operator 50 may rout the SMS message directly to hub 15. At step 92, message handling system 12 then forwards the message on to the relevant SMS campaign manager 30 (or its associated ASP or CSP) for processing in accordance with the campaign.

Since SMS hubs 40 routinely establish and collect fees from the mobile network 50 of the originating message for terminating (i.e., completing the delivery of)) messages into system 10, the party operating system 10 preferably enters into direct arrangements with SMS hubs 40 to facilitate billing and revenue-sharing in relation to messages sent to the international SMS destination numbers hosted by system 10. On the other hand, where hub 15 receives SMS messages directly from mobile network operators 50, the party operating system 10 preferably enters into revenue-sharing arrangements directly with the mobile networks 50 on which the SMS messages originate. If desired, system 10 may also participate in return path traffic in relation to premium message content (for e.g., ring tones or photographs) sent from the SMS campaign managers 30 back to SMS users 60.

In terms of revenue flow, when a mobile user sends an SMS message to an international SMS destination number hosted by system 10, the user pays the mobile network operator 50 a certain charge $X, as illustrated at 86 in FIG. 2. A proportion of $X (i.e., $Y) of that charge is then paid either directly to the destination network operator or to the relevant SMS hub operator 40 (the latter case being indicated in FIG. 2). That party in turn pays a proportion of $Y (i.e., $Z) to system 10 as illustrated at step 88. As noted above and as shown at step 94, system 10 may optionally share a proportion of its revenue $Z with the SMS number administrator 20 granting the rights to use the particular international SMS destination number for that SMS campaign. In this manner, the right to use many international SMS destination numbers can be obtained up front by system 10 with the administrators 20 only being paid when the international SMS destination numbers are actually used in SMS campaigns. In some cases, system 10 may also optionally share a proportion of its revenue $Z with the SMS campaign manager 30 running the campaign. More generally, it will also be appreciated that the revenue may be shared on any basis including as a percentage of the charges or as a fixed charge per message.

Within system 10, rating and billing sub-system 14 preferably provides a near real-time view of traffic into the international SMS destinations hosted by system 10, securely and reliably recording all details of messages sent to those destinations and handled by sub-system 12. Rating and billing sub-system 14 also prepares bills for charging SMS hubs 40 and/or network operators 50 (as well as any other traffic sources) and payment statements for SMS number administrators 20 (and any other revenue share partners).

With the above-described revenue sharing arrangement, SMS campaign managers 30 are effectively traffic promoters who encourage users to send SMS messages to the international SMS destination number. Managers 30 thereby serve to generate revenue for system 10, which shares in the associated mobile network charges that users pay for sending those messages. In addition, the vast majority of the SMS messages sent to the international SMS destination numbers are international SMS messages incurring higher charges ion comparison to domestic SMS messages.

While the invention has been described in conjunction with specific embodiments, it is evident that numerous alternatives, modifications, and variations will be apparent to those skilled in the art in light of the foregoing description. For example, users 60 need not necessarily use mobile communication devices to send SMS messages since the latter can also be sent from other devices and applications, such as a desktop computer running SKYPE communication software. Furthermore, it will be appreciated that not all existing and envisaged messaging telephony systems use the SMS protocol. For example, the Multimedia Messaging Service (MMS) in GSM networks and the Short Mail service in NTT Docomo's mobile networks in Japan use different protocols. Therefore, as already noted above, the system and method of the present invention can be applied to any messaging protocol that uses telephone or short code numbers as destination addresses since they are not dependent on the specifics of the text messaging protocol used. Finally, in terms of country codes, it will be appreciated that any entity assigned a country code including global satellite communication systems are also considered “countries” for the purposes of the present invention.

1. A method of running a telephony messaging campaign directed at users in a plurality of countries, comprising:
selecting an international messaging destination number for users in the plurality of countries to participate in the campaign, the international messaging destination number comprising an international country code for a particular country or region followed by a national destination number for that particular country or region, the international country code comprising one or more digits and the national destination number comprising a plurality of digits; and
inviting users to participate in the campaign by communicating the international messaging destination to the users in the format of an international direct dialing prefix followed by a string comprising at least one letter conventionally associated, on a standard telephone keypad, with at least one digit in the international country code of the international messaging destination number.

2. The method of claim 1, wherein communicating the international direct dialing prefix consists of communicating a ‘+’ sign representative of the international direct dialing access code from the country in which the users are based.

3. The method of claim 1, wherein the string further comprises letters conventionally associated with at least some of the digits in of the national destination number.

4. The method of claim 3, wherein the string further comprises letters conventionally associated with all of the digits in the country code.

5. The method of claim 4, wherein the string consists of letters conventionally associated with all of the digits in the country code and all of the digits in the national destination number.

6. The method of claim 1, wherein the national destination number is a short code number.

7. The method of claim 1, wherein communicating the international messaging destination number to the users comprises communicating said number via a Web site associated with the campaign.

8. The method of claim 1, wherein communicating the international messaging destination number to the users comprises communicating said number via a radio or television announcement associated with the campaign.

9. The method of claim 1, wherein selecting the international messaging destination number includes obtaining the right to use the international messaging destination number from an administrator located within the country in which the international messaging destination number is based.

10. The method of claim 1, wherein the international messaging destination number can receive SMS messages, and the telephony messaging campaign is an SMS campaign.

11. A method for running a plurality of telephony messaging campaigns, each directed at users in a plurality of countries, comprising:
acquiring the rights to use a plurality of international messaging destination numbers in a plurality of countries, each international messaging destination number comprising an international country code for a particular country or region followed by a national destination number for that particular country or region, the international country code comprising one or more digits and the national destination number comprising a plurality of digits;
associating each international messaging destination number with a telephony messaging campaign run by a campaign manager;
for each telephony messaging campaign, receiving, via a plurality of telephony messaging operators located in the plurality of countries, telephony messages from users who participate in said campaign;
forwarding said telephony messages to the campaign manager for that campaign; and
charging each telephony messaging operator an amount based on the telephony messages delivered via said telephony messaging operator.

12. The method of claim 11, wherein the telephony messages are received via a plurality of messaging hub operators, the method comprising charging each messaging hub operator a portion of the mobile network charge revenues incurred by users whose telephony messages are delivered via said messaging hub operator.

13. The method of claim 11, wherein the telephony messages are received via a plurality of mobile network operators, the method comprising charging each mobile network operator a portion of the mobile network charge revenues incurred by users whose telephony messages are delivered via said mobile network operator.

14. The method of claim 11, further comprising providing a portion of the amount charged to telephony messaging operators in connection with a particular telephony messaging campaign to an administrator who granted the rights to use the associated international messaging destination number.

15. The method of claim 11, further comprising, for each telephony messaging campaign, inviting users to participate in the campaign by communicating the international messaging destination to the users in the format of an international direct dialing prefix followed by a string comprising at least one letter conventionally associated, on a standard telephone keypad, with at least one digit in the international country code of the international messaging destination number.

16. The method of claim 15, wherein the string further comprises letters conventionally associated with at least some of the digits in of the national destination number, and wherein communicating the international direct dialing prefix consists of communicating a ‘+’ sign representative of the international direct dialing access code from the country in which the users are based.

17. A system for running a telephony messaging campaign directed at users in a plurality of countries, comprising:
a messaging handling system operative to associate each of a plurality of international messaging destination numbers with a telephony messaging campaign run by a campaign manager, each international messaging destination number comprising an international country code for a particular country or region followed by a national destination number for that particular country or region, the international country code comprising one or more digits and the national destination number comprising a plurality of digits, the messaging handling system being further operative to receive, via a plurality of telephony messaging operators located in the plurality of countries, telephony messages from users who participate in each telephony messaging campaign and to forward said telephony messages to the campaign manager for said campaign; and
a billing and rating system operative to charge each telephony messaging operator an amount based on the telephony messages delivered to said message handling system via said telephony messaging operator.

18. The system of claim 17, wherein the messaging handling system receives telephony messages via a plurality of messaging hub operators and the billing and rating system charges each messaging hub operator a portion of the mobile network charge revenues incurred by users whose telephony messages are delivered via said messaging hub operator.

19. The system of claim 17, wherein the messaging handling system further comprises a hub for receiving telephony messages directly via a plurality of mobile network operators and the billing and rating system charges each mobile network operator a portion of the mobile network charge revenues incurred by users whose telephony messages are delivered via said mobile network operator.

20. The system of claim 17, wherein the billing and rating system further pays a portion of the amount charged to telephony messaging operators in connection with a particular telephony messaging campaign to an administrator who granted the rights to use the international messaging destination number associated with said campaign.
